(19) United States
(12) Patent Application Publication
(10) Pub. No.: US 2008/0002653 A1
(43) Pub. Date: Jan. 3, 2008

(54) Method of connecting a new discovered AP by early 4-way handshaking

(75) Inventors: Pi-Sung Hung, Keelung City (TW); Bor-Wen Yang, Sijhih City (TW)

Correspondence Address: BIRCH STEWART KOLASCH & BIRCH, PO BOX 747, FALLS CHURCH, VA, 22040-0747, US

(73) Assignee: Accton Technology Corporation

(21) Appl. No.: 11/806,797

(22) Filed: Jun. 4, 2007

(30) Foreign Application Priority Data
Jun. 13, 2006 (TW) 095121084

(51) Int. Cl. H04Q 7/24; H04K 1/00; H04Q 7/00

(52) U.S. Cl. 370/338; 380/270; 455/411; 713/168

(57) ABSTRACT

The present invention discloses a method of the Early 4-Way Handshaking, which is part of the Advanced Pre-Authentication (APA). In the standard 802.11i pre-authentication procedure, the 4-way handshaking is performed in the reassociation or association process. Therefore, more time will be taken for the client to reassociate/associate with the new AP (access point.) With the method of the Early 4-Way Handshaking, we limit the reassociation/association negotiation within two messages exchanged, and perform the 4-way handshaking in the pre-authentication phase.

### FIELD OF THE INVENTION

The present invention relates in general to local-area network communication protocols, and, in particular, to wireless local-area network communication protocols.

### BACKGROUND OF THE INVENTION

With fast-growing Internet, a variety of Internet service is closely related to human life. It also means that the human's dependency on the Internet has been increasing. For the reasons, more and more private users built local-area network by themselves in order to use all kinds of Internet service more conveniently in their daily life. In the early local-area network days, the setting of network was limited in a wired form, and the equipments are usually high-priced. Consequently, only few advanced users are capable to set a local-area network by themselves. However, recently, the rapidly progressing manufacturing technology in the electronic industries has resulted in the price of Internet appliances to more rational levels, and also promoted the general users' motivation of setting a network on their own.

In addition to setting the communication protocols between computers, it is also a difficult problem to configure the network cables. How to give consideration to both the aesthetics and efficiency is expected to be solved. However, the desires of solving difficult problems will become the motive power of technical developments. On the one side to prevent from a tangle of cables, and one the other side to accompany the advancement of wireless communication technology, wireless local-area network (WLAN) comes with the tide of fashion. In virtue of the nature of wireless local-area network, there should be more configurations and relevant authentication modes to enhance the Internet security. Such kinds of authentication mode can also provide an acceptable communication quality if it is not necessary for users to access across many access points. In contrast, if it is necessary to roam across many access points, there would be a significant defect in the existed authentication modes.

Because of its low cost and easy setting, more and more wireless local-area network access points are configured in densely populated areas. In virtue of the nature of wireless local-area network, many authentication modes have to be reset as the clients are handed off from one access point to another. It results in temporarily disconnecting between the clients and Internet. If we apply the current technique in delivering voice data, it might result in disconnecting the communication between client and server, which is an unacceptable defect. In order to resolving this problem, a fast authentication method in wireless local-area network is ultimately required.

### SUMMARY OF THE INVENTION

Along with the extensive construction of wireless local-area network (hereinafter referred to as the “WLAN”), a variety of service options within the framework gradually emerge, for example, a VoIP WLAN phone, and those products need to be designed according to the specifications of WLAN. In other words, it is necessary for such products to support the communication protocols of the IEEE802.11 series. However, to decide which protocols are necessary is dependent on the different requirements of different products. In WLAN, one of the most important issues is how to provide a secure communication, that is, how to control and manage the clients permitted to log in the system. In this respect, IEEE802.11i is still the most extensively used communication protocol nowadays. Even so, with the novel service introducing, the present inventor has discovered the deficiency of the products designed according with the standards of IEEE802.11i and the present invention comes with the tide of fashion.

The present invention discloses a method for associating wireless network devices to a new access point, and especially which can be performed by the Early 4-Way Handshaking. The present invention includes performing the 4-Way Handshaking after clients' finding a new access point, then performing the reassociation/association negotiation with the new WLAN access point for the purpose of reducing the link time and/or shortening the time taken to disconnect from the original access point. In the stage of reassociation/association, as the WLAN authentication terminal receives an Extensible Authentication Protocol (hereinafter referred to as the “EAP”) Success message, it requires the WLAN client to enhance the pre-authentication proprietary by EAP.

Furthermore, the present invention includes the following steps performing between users and authentication terminals: a) performing the Probe Requests and Responses; b) performing the EAP; c) requiring EAP-Identity and Response. The Extensible Authentication Protocol (EAP), is also defined in RFC 2284, is a general protocol for exchanging authentication. By means of it, other advanced authentication protocols can be implemented.

### BRIEF DESCRIPTION OF THE DRAWINGS

FIG. 1 is a system block diagram illustrating that one client roam from one WLAN access point to another.

FIG. 2 is a flow diagram illustrating the process that a client finds a new WLAN access point, prepares to leave the original WLAN access point, and reassociates/associates to the new one.

FIG. 3 is a flow diagram illustrating the process of Early 4-Way Handshaking protocol for the WLAN client and the new access point.

### DETAILED DESCRIPTION OF THE PREFERRED EMBODIMENT

The preferred embodiments and accompanying drawings of the invention described below are intended to exemplify, rather than limit, aspects of the Invention. Therefore, it should be recognized that the present invention can be practiced in a wide range of other embodiments besides those explicitly described, and the scope of the present invention is not limited by any embodiments. It should be defined by the appended claims and the related technical field.

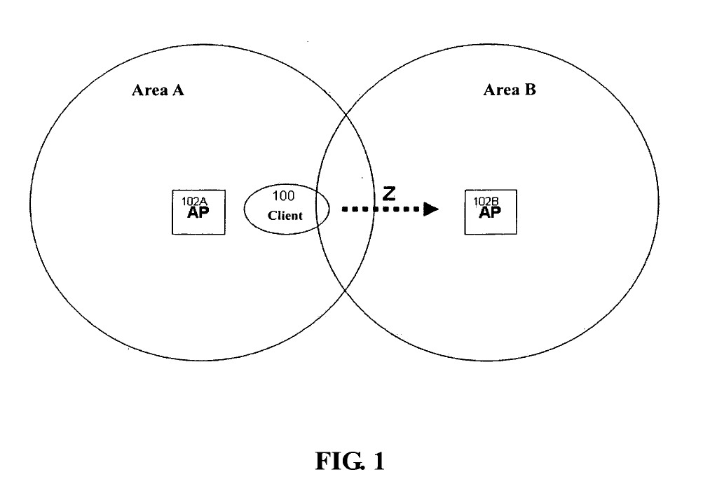

Refer to the system block diagram shown in FIG. 1. It illustrates that the client 100 roams from the area A of coverage for the access point 102A to the area B of coverage for the access point 102B. As shown in FIG. 1, the client 100 moves from area A to area B along the Z-axis. While the client contacts the area B of coverage for the access point 102B, an access request message is sent to the WLAN access point, and the standard authentication procedure is initiated in general. However, the present inventor has found a temporary disconnect on the client resulted from following the standard procedure. That is unacceptable for the clients in voice communication. The reason of the problem is because the 4-Way Handshaking, which is critical the standard 802.11i pre-authentication procedure, is performed in the reassociation or association process. In other words, the client 100 needs to perform the 4-Way Handshaking procedure after disconnecting with the WLAN access point 102A to be able to reassociate with the WLAN access point 102B. Such an inherent limitation is the nature of 802.11i.

In order to solve this problem, the present invention discloses a method named Advanced Pre-Authentication (APA), which includes the Neighbor AP Notification and, especially, the Early 4-Way Handshaking. It is the primary purpose of the present invention to efficiently shorten the disconnecting time during the transfer period of access points for APA-supported WLAN clients who roam between the APA-supported WLAN access points.

With the method of the Early 4-Way Handshaking, the reassociation/association negotiation is limited within two messages exchanged, and the 4-way handshaking is performed in the pre-authentication phase. In virtue of the 4-way handshaking being necessary for establishing secure connectivity, performing the 4-way handshaking in the pre-authentication phase can lessen the time spent on reassociation/association. That is to say, the disconnecting time for transferring from the WLAN access point 102A to the access point 102B is obviously shorten.

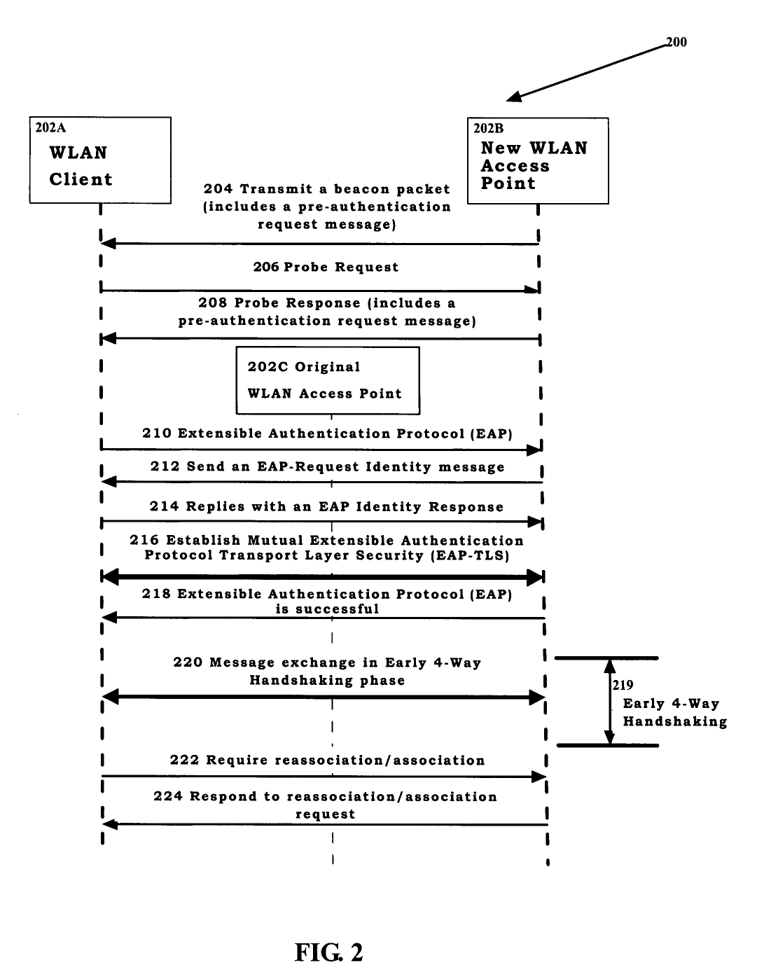

Refer to the flow diagram shown in FIG. 2. It illustrates the process that the WLAN client 202A finds a new WLAN access point 202B, and then prepares to de-associate from the original WLAN access point 202C and reassociates/associates to the new one. As FIG. 2 shown, the process 200 of reassociation/association starts by the step 204 of transmitting a beacon packet (includes a pre-authentication request message) from the new WLAN access point 202B to the WLAN client 202A, which lets the client 202A know the existence of the new access point 202B. In step 206, the WLAN client 204A transmits a Probe Request to the WLAN access point 202B, and then waits for a Probe Response (includes a pre-authentication request message) from the new WLAN access point 202B at step 208. The process from step 210 which illustrates an Extensible Authentication Protocol (hereinafter referred to as the “EAP”) process establishes a temporary secure connection between a client and an access point to ensure the security of authenticated key exchange. In the past, it is necessary to perform the Extensible Authentication Protocol (EAP) and the 4-way handshaking twice respectively before the completion of reassociation/association. In contrast, the present invention simplifies the reassociation/association procedure by immediately performing the Early 4-Way Handshaking after the first EAP implementation. That is able to efficiently lessen the time spent on reassociation/association. In step 210, the WLAN client 202A sends an EAP Start message to the new WLAN access point 202B, and then in step 212, the WLAN access point 202B sends an EAP-Request Identity message to the WLAN client 202A. In step 214, the WLAN client 202A replies with an EAP Identity Response to the new WLAN access point 202B. After the above steps are completed, Extensible Authentication Protocol Transport Layer Security (EAP-TLS) is configured to provide a strong security platform on which the Early 4-Way Handshaking 219 subsequently performs. In step 218, the WLAN access point 202B replies the WLAN client 202A an EAP Success message, and in the meantime it is well-prepared to initiate the Early 4-Way Handshaking. Next, in step 219, the Early 4-Way Handshaking is performing. The message exchange in the Early 4-Way Handshaking phase is simply indicated in step 220 in FIG. 2, and the processing steps will be described in detail in the following subsections. After the Early 4-Way Handshaking, the WLAN client 202A sends a reassociation/association request frame to the WLAN access point 202B, as shown in step 222. In step 224, the WLAN access point 202B responds with an association response frame and the connection is established.

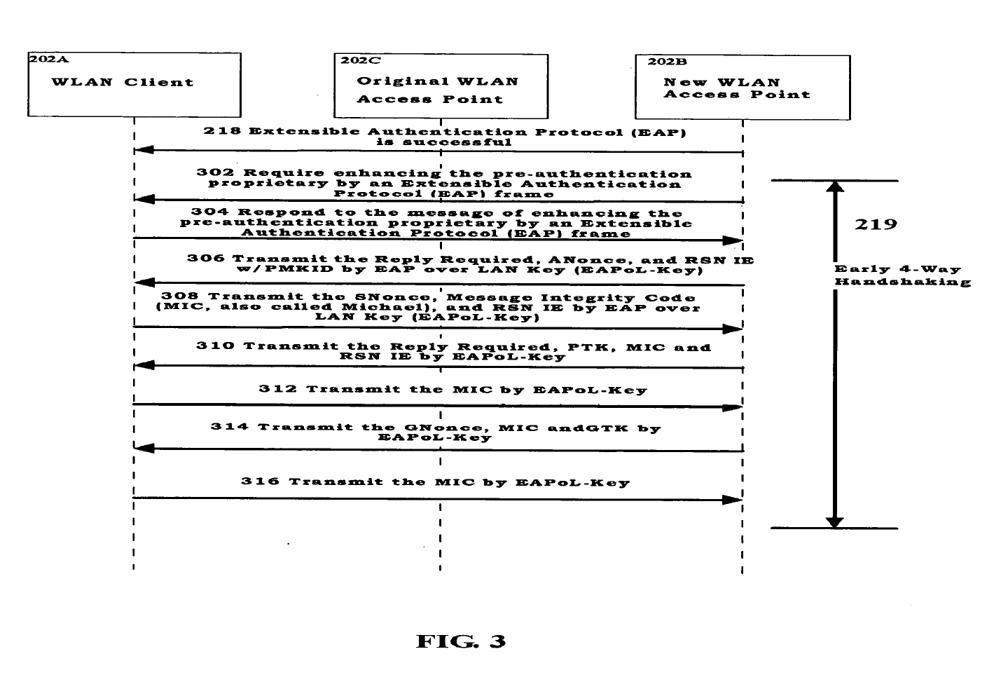

Refer to the flow diagram shown in FIG. 3. It illustrates the Early 4-Way Handshaking 219 process between the WLAN client 202A and the new WLAN access point 202B. As aforementioned, after the WLAN access point 202B replying the WLAN client 202A an EAP Success message shown in step 218, the new WLAN access point 202B requires the WLAN client 202A to enhance the pre-authentication proprietary by an EAP frame in step 302, and waits to receive a response from the WLAN client 202A. If no response is received within an allotted period, the new WLAN access point 202B repeats to send the request messages of enhancing the pre-authentication proprietary. After retransmitting for a fixed number of times and still no response being obtained, the new WLAN access point 202B stops performing the Early 4-Way Handshaking 219. If the WLAN client 202A successfully responds to the message of enhancing the pre-authentication proprietary (that is to say, both the access point and WLAN client support for the function of enhancing the pre-authentication.), in step 304, after the first handshaking is completed, it performs a series of exchanges of essential data. In step 306, the new WLAN access point 202B transmits the Request/Response message, ANonce, and RSN IE w/PMKID (Pairwise Master Key Identifier in Robust Security Network Information Element) to the WLAN client 202A by EAP over LAN Key (hereinafter referred to as the “EAPoL-Key”) frames, followed by sending SNonce, a Message Integrity Code (MIC, also called Michael), and RSN IE (Robust Security Network Information Element) from the WLAN client 202A to the new WLAN access point 202B by EAPoL-Key (EAP over LAN Key) frames in step 308. Please refer to step 310, the new WLAN access point 202B is responsive to sending the Request/Response message, a Pairwise Temporary Key (PTK), a Message Integrity Code (MIC), and RSN IE (Robust Security Network Information Element) to the WLAN client 202A by EAPoL-Key (EAP over LAN Key) frames. Subsequently, in step 312, the WLAN client 202A transmits the Message Integrity Code (MIC) to the new WLAN access point 202B by EAPoL-Key (EAP over LAN Key) frames. Afterwards, the new WLAN access point 202B is responsive to an instruction to transmit GNonce, a Message Integrity Code (MIC), and a Group Temporary Key (GTK) to the WLAN client 202A by EAPoL-Key (EAP over LAN Key) frames in step 314. Finally, referring to step 316, the WLAN client 202A is instructed to send the MIC to the new WLAN access point 202B by EAPoL-Key (EAP over LAN Key) frames, thereby completing the Early 4-Way Handshaking.

The proper nouns related to WLAN in the present invention are easily understood by people of ordinary skill in the art. Hence, these terms are not exhaustively detailed in the present specification to avoid confusing the highlight of the invention.

Furthermore, the Early 4-Way Handshaking is not only operated in Infrastructure mode, but also in Ad-hoc mode. Thereby, the new WLAN access point can be substituted by any WLAN access point.

Although specific embodiments have been illustrated and described, it will be obvious to those skilled in the art that various modifications may be made without departing from what is intended to be limited solely by the appended claims.

What is claimed is:

1. A method of connecting a WLAN device to a new WLAN authentication terminal, said method comprising:
Performing a pre-authentication procedure, followed by performing early 4-way handshaking after said new WLAN authentication terminal is discovered by a WLAN client; and
performing a reassociation/association negotiation with said new WLAN authentication terminal to reduce link time and/or shorten the disconnection time due to disconnecting from an original authentication port.

2. The method of claim 1, wherein said WLAN authentication terminal requires said WLAN client to enhance pre-authentication proprietary through a Extensible Authentication Protocol (EAP) after receiving an EAP success message during reassociation/association.

3. The method of claim 2, wherein said WLAN authentication terminal includes a WLAN access point.

4. The method of claim 1, further comprising steps prior to performing said pre-authentication:
performing a probe request by WLAN client; and
performing a probe response by WLAN access point; and
performing Extensible Authentication Protocol (EAP) by authentication server; and
requiring EAP identity response from WLAN client.

5. A method of early 4-way handshaking, comprising:
requesting a WLAN client to enhance pre-authentication proprietary by Extensible Authentication Protocol (EAP) by a WLAN authentication terminal;
reposing to said WLAN authentication terminal by enhancing said pre-authentication proprietary through said Extensible Authentication Protocol via said WLAN client;
transmitting first data from said WLAN authentication terminal to said WLAN client by means of EAPoL-Key (EAP over LAN Key) frames;
transmitting second data from said WLAN client to said WLAN authentication terminal by means of EAPoL-Key (EAP over LAN Key) frames;
transmitting third data from said WLAN authentication terminal to said WLAN client by means of EAPoL-Key (EAP over LAN Key) frames;
transmitting fourth data from said WLAN client to said WLAN authentication terminal by means of EAPoL-Key (EAP over LAN Key) frames;
transmitting fifth data from said WLAN authentication terminal to said WLAN client by means of EAPoL-Key (EAP over LAN Key) frames; and
transmitting sixth data from said WLAN client to said WLAN authentication terminal by means of EAPoL-Key (EAP over LAN Key) frames.

6. The method of claim 5, wherein said WLAN authentication terminal requires said WLAN client to enhance pre-authentication proprietary by said Extensible Authentication Protocol after receiving an EAP success message during reassociation/association.

7. The method of claim 5, wherein said WLAN authentication terminal includes a WLAN access point.

8. The method of claim 5, wherein said WLAN client includes a WLAN workstation and a WLAN access point.

9. The method of claim 5, wherein said first data includes a request for response, an ANonce, and RSN IE w/PMKID (Pairwise Master Key Identifier in Robust Security Network Information Element).

10. The method of claim 5, wherein said second data includes a SNonce, a Message Integrity Code (MIC) and RSN IE (Robust Security Network Information Element).

11. The method of claim 5, wherein said third data includes a request for response, a Pairwise Temporary Key (PTK), a Message Integrity Code (MIC), and RSN IE (Robust Security Network Information Element).

12. The method of claim 5, wherein said fourth data includes a Message Integrity Code (MIC).

13. The method of claim 5, wherein said fifth data includes GNonce, a Message Integrity Code (MIC), and a Group Temporary Key (GTK).

14. The method of claim 5, wherein said sixth data includes a Message Integrity Code (MIC).

15. The method of claim 6, wherein said WLAN authentication terminal waits for a first interval in order to receive a response from said WLAN client.

16. The method of claim 15, wherein said first interval is approximately in a range from 2 seconds to 10 seconds, and an appropriate value is 5 seconds.

17. The method of claim 6, wherein said WLAN authentication terminal retransmits EAP-Request messages plural times if no response is received from said WLAN client.

18. The method of claim 17, wherein said number of times of retransmitting said EAP-Request messages is less than 6.
